(19) United States
(12) Patent Application Publication
(10) Pub. No.: US 2026/0097837 A1
(43) Pub. Date: Apr. 9, 2026

(54) SYSTEMS AND METHODS FOR CONTINUOUS MANUFACTURE OF HIGH-ALTITUDE BALLOONS

(71) Applicants: Sarah Ann Schubert, Berkeley, CA (US); Daniel Patrick Bowen, Oakland, CA (US); Alexander Sullivan Wong, South Pasadena, CA (US)

(72) Inventors: Sarah Ann Schubert, Berkeley, CA (US); Daniel Patrick Bowen, Oakland, CA (US); Alexander Sullivan Wong, South Pasadena, CA (US)

(21) Appl. No.: 19/353,646

(22) Filed: Oct. 9, 2025

Related U.S. Application Data
(60) Provisional application No. 63/705,386, filed on Oct. 9, 2024.

(51) Int. Cl. B64B 1/58; B64F 5/10

(52) U.S. Cl. CPC B64B 1/58; B64F 5/10

(57) ABSTRACT

Systems and methods for continuous manufacture and launch of high-altitude balloons are described. An exemplar method includes: (i) continuously producing a tubular film; (ii) receiving the film at a buffering subassembly; (iii) producing an inflatable tubular envelope; (iv) sealing a portion of a first end; (v) dispensing a predetermined volume of gas admixture; (vi) sealing a second end to produce a balloon; (vii) separating the balloon; (viii) conveying the balloon; and (ix) launching the balloon from a co-located facility. In one embodiment, a gathering step creates a deflated internal cavity adjacent to an inflated internal cavity to accommodate volumetric expansion of the gas admixture during ascent to a target altitude.

### RELATED APPLICATION

This application claims priority to provisional application no. 63/705,386, filed on Oct. 9, 2024, which is incorporated herein by reference for all purposes.

### FIELD

The present arrangements and teachings relate generally to novel systems and methods for high-altitude balloon manufacturing. More particularly, the present arrangements and teachings relate to novel systems and methods for continuous high-altitude balloon manufacturing and launching at a single location.

### BACKGROUND

Production of conventional high-altitude balloons includes obtaining a plastic film and/or latex material that is manufactured at a plastic or latex production facility. That plastic film and/or latex is transported to a balloon manufacturing facility, where the high-altitude balloon is manufactured. Finally, the manufactured high-altitude balloon is transported to a launch site, where it is deployed. In each of these locations and during transportation, the high-altitude balloon and/or high-altitude balloons may be delayed and damaged. Unfortunately, this disjointed, time consuming, and labor intensive process inhibits rapid manufacturing and launch of high-altitude balloons.

What is needed, therefore, are systems and methods for rapid and continuous manufacture of high-altitude balloons at the location where the high-altitude balloons are launched.

### SUMMARY

To achieve the foregoing, the present teachings provide novel systems and methods for continuous manufacturing and launching of high-altitude balloons. In one aspect, the present arrangements provide novel systems for continuous manufacture and launch of high-altitude balloons. An exemplar of such system for continuous manufacture and launch of high-altitude balloons includes: (i) a film production apparatus; (ii) a buffering subassembly; (iii) a first sealing mechanism; (iv) a gas reservoir; (v) a gas diffuser; (vi) a second sealing mechanism; (vii) a separating mechanism; (viii) a conveying assembly; and (ix) a balloon launcher.

The film production apparatus is configured to continuously produce a tubular film. The buffering subassembly is communicatively coupled to the film production apparatus and is capable of producing an inflatable tubular envelope extending from a first end to a second end and having defined therein an internal cavity.

The first sealing mechanism is configured to at least partially seal the first end of the inflatable tubular envelope. The gas reservoir contains a gas, and a gas diffuser is coupled to the gas reservoir and configured to dispense into the internal cavity a predetermined volume of gas.

The second sealing mechanism is configured to seal the second end of the inflatable tubular envelope to produce the high-altitude balloon. The separating mechanism is configured to separate the high-altitude balloon from the inflatable tubular envelope.

The conveying assembly is configured to displace the high-altitude balloon from the separating mechanism, and a balloon launcher is designed to receive the high-altitude balloon from the conveying assembly and configured to launch the high-altitude balloon.

In one embodiment of the present arrangements, the film production apparatus includes at least one film production apparatus selected from a group comprising film blower, caster, flat die extruder, laminator, co-extruder, and molds and dipper.

In another embodiment of the present arrangements, the first sealing mechanism and/or the second sealing mechanism is a sealing mechanism selected from a group comprising heat sealer, cold sealer, laser sealer, impulse continuous band sealer, impulse continuous wheel sealer, radio frequency welder, and vertical form fill sealer.

In yet another embodiment of the present arrangements, the first sealing mechanism is configured to seal the first end of the inflatable tubular envelope after the gas diffuser dispenses the predetermined volume of gas into the internal cavity.

The buffering subassembly, in a further embodiment of the present arrangements, is designed to receive the tubular film at a receiving velocity and distribute the inflatable tubular envelope at an exiting velocity that is the same as or different than the receiving velocity. In another embodiment of the present arrangements, the buffering subassembly includes one or more tension accumulators configured to maintain tubular film tension during variable exiting velocity.

In yet another embodiment of the present arrangements, the inflatable tubular envelope is made from at least one material selected from a group comprising latex, linear low-density polyethylene, polyethylene, polyamide, polyethylene terephthalate (PET), biaxially oriented polyethylene terephthalate (BOPET), ethylene-vinyl acetate (EVA), and polyvinylidene chloride (PVDC).

In a further embodiment of the present arrangements, the inflatable tubular envelope has a uniform sidewall thickness that ranges from between about 0.5 micrometers and about 100 micrometers.

In another embodiment of the present arrangements, an internal diameter of the internal cavity is substantially similar between the first end and the second end. In yet another embodiment of the present arrangements, the internal diameter ranges from between about 1 meter and about 60 meters.

In a further embodiment of the present arrangements, the gas includes a lifting gas and a payload in predetermined proportions. The lifting gas may be at least one lifting gas selected from a group comprising helium, hydrogen, coal gas, ammonia, and methane. In one embodiment of the present arrangements, the payload is an aerosol composition. The aerosol composition may be any solid, liquid and/or gas that is added to the lifting gas. The payload may include at least one aerosol composition selected from a group comprising SO₂, H₂S, H₂SO₄, OCS, CaCO₂, AlO, Al₂O₂, Al₂O₃, SiO₂, TiO₂, solid sulfur, diamond dust, and black carbon.

In a further embodiment of the present arrangements, the separating mechanism includes at least one mechanism selected from a group comprising slitting roller blades, scissor blades, laser cutters, and knife blades.

In another embodiment of the present arrangements, the conveying assembly includes air blowers configured to push and guide the high-altitude balloon without physical contact between the conveying assembly and the high-altitude balloon.

In yet another embodiment of the present arrangements, the system further includes a controller operably connected to at least one component selected from the group comprising the film production apparatus, the buffering subassembly, the first sealing mechanism, the second sealing mechanism, the gas diffuser, the separating mechanism, the conveying assembly, and the balloon launcher. The controller is configured to continuously monitor at least one parameter selected from the group consisting of environmental conditions, mission requirements, and flight trajectory predictions. The controller controls operation of the at least one component based on the monitored parameter.

In a further embodiment of the present arrangements, the controller controls operation of the at least one component to manufacture the high-altitude balloon such that, when launched, the balloon achieves at least one target selected from the group consisting of target flight path, target burst altitude, target maximum altitude, and target landing zone.

In another embodiment of the present arrangements, the at least one component dynamically adjusts at least one of inflatable tubular envelope thickness, gas composition, inflatable tubular envelope thickness, fill volume, gas temperature, inflatable tubular envelope length, inflatable tubular envelope material composition, or internal diameter of inflatable tubular envelope.

In yet another aspect, the present arrangements provide a system for continuous manufacture of aerosol injection balloons. The system includes: (i) a gas admixture reservoir; (ii) a gas diffuser; (iii) a sealing mechanism; and (iv) a gathering subassembly.

The gas admixture reservoir contains an aerosol composition and a lifting gas composition, and a gas diffuser coupled to the gas admixture reservoir and configured to dispense a predetermined volume of gas admixture into an inflatable tubular envelope.

The sealing mechanism is configured to partially seal a first end of the inflatable tubular envelope to create an unsealed portion and to seal both ends after gas dispensing. The gathering subassembly is configured to gather a section of the inflatable tubular envelope adjacent to a second end to form a deflated internal cavity. The gas diffuser is configured to dispense the predetermined volume of gas admixture through the unsealed portion to define an inflated internal cavity, the predetermined volume including a predetermined volume of the aerosol composition and a predetermined volume of lifting gas composition corresponding to a target altitude of an aerosol injection balloon.

In one embodiment of the present arrangements, the system for continuous manufacture of aerosol injection balloons further includes a film production apparatus configured to continuously produce the inflatable tubular envelope.

In another aspect, the present arrangements provide a high-altitude aerosol injection balloon including an inflatable tubular envelope extending from a sealed first end to a sealed second end and having defined therebetween an internal cavity. The inflatable tubular envelope has an inflated internal cavity and a deflated internal cavity. The inflated internal cavity is at or near a first end and contains a gas admixture including a predetermined volume of gas admixture. The predetermined volume of gas admixture includes a predetermined volume of an aerosol composition and a predetermined volume of a lifting gas composition corresponding to a target altitude of the aerosol injection balloon.

The deflated internal cavity is adjacent to a second end formed by a gathered portion of the inflatable tubular envelope. The deflated internal cavity and the inflated internal cavity are configured to accommodate volumetric expansion of the gas admixture under decreasing atmospheric pressure during ascent to the target altitude. Upon reaching the target altitude, continued expansion of the gas admixture exceeds a combined accommodation capacity of the deflated internal cavity and the inflated internal cavity, causing rupture of the aerosol injection balloon and dispersal of the aerosol composition at the target altitude.

In one embodiment of the present arrangements, the inflatable tubular envelope is reinforced with polymer fibers to enhance tear resistance and puncture resistance.

In another embodiment of the present arrangements, the gathered portion is secured with temporary straps configured to release during balloon expansion at altitude.

In yet another embodiment of the present arrangements, the aerosol composition includes particles having a diameter that ranges from between about 0.0001 micrometers and 2 micrometers.

In a further embodiment of the present arrangements, the target altitude ranges from between about 15 kilometers and about 35 kilometers. In another embodiment of the present arrangements, the target altitude is a target altitude range.

In another aspect, the present teachings provide a method for continuous manufacture of an aerosol injection balloon. The method includes: (i) producing an inflatable tubular envelope extending from a first end to a second end and having defined therebetween an internal cavity, and creating an unsealed portion at the first end by partially sealing the first end; (ii) inserting, through the unsealed portion of the first end and into the internal cavity, a gas diffuser, and (iii) dispensing, using the gas diffuser and into the internal cavity at or near the first end, a predetermined volume of gas admixture to define an inflated internal cavity at or near the first end. The predetermined volume of gas admixture includes a predetermined volume of an aerosol composition and a predetermined volume of a lifting gas composition corresponding to a target altitude of the aerosol injection balloon.

The method further includes (iv) gathering a section of the inflatable tubular envelope adjacent to the second end to define a deflated internal cavity. The deflated internal cavity and the inflated internal cavity are configured to accommodate expansion of the predetermined volume of gas admixture during ascent to the target altitude.

Another element includes (v) sealing the first end and the second end such that the deflated internal cavity is disposed adjacent to the inflated internal cavity inside the aerosol injection balloon. During ascent to the target altitude, the deflated internal cavity and the inflated internal cavity accommodate volumetric expansion of the gas admixture under decreasing atmospheric pressure, and upon reaching the target altitude, continued expansion of the gas admixture exceeds a combined accommodation capacity of the deflated internal cavity and the inflated internal cavity, causing rupture of the aerosol injection balloon and dispersal of the aerosol composition at the target altitude.

In one embodiment of the present teachings, sealing the first end includes removing the gas diffuser from the unsealed portion of the first end.

In another embodiment of the present teachings, dispensing the predetermined volume of gas admixture into the internal cavity includes preheating or precooling the gas admixture.

In yet another embodiment of the present teachings, dispensing the predetermined volume of gas admixture into the internal cavity includes ionizing the gas admixture to reduce the static charge of the gas admixture.

In a further embodiment of the present teachings, gathering a portion of the inflatable tubular envelope includes rolling the inflatable tubular envelope around the first end to create a cylindrical bundle or folding the inflatable tubular envelope into multiple portions such that the folded portions are adjacent to other folded portions to form a Z-fold.

In another embodiment of the present teachings, the first end is a leading end of the inflatable tubular envelope that is distal to the buffering assembly, the second end is a trailing end of the inflatable tubular envelope that is proximate to the buffering assembly, and gathering the portion of the inflatable tubular envelope adjacent to the first edge is performed before or contemporaneously with the dispensing a predetermined volume of gas admixture.

In yet another embodiment of the present teachings, the method further includes moving, using air blowers and/or rollers, the aerosol injection balloon to a co-located launch pad, and launching the aerosol injection balloon.

In another aspect, the present teachings provide a method for continuous manufacture and launch of high-altitude balloons. The method includes (i) continuously producing a tubular film, and (ii) receiving, at a buffering subassembly, the tubular film. The method further includes (iii) producing, from the tubular film and using the buffering subassembly, an inflatable tubular envelope extending from a first end to a second end and having defined therein an internal cavity, and sealing, using a first sealing mechanism, at least a portion of the first end of the inflatable tubular envelope. The method includes (iv) dispensing, using a gas diffuser, a predetermined volume of gas into the internal cavity, to produce the inflatable tubular envelope having defined therein an inflated internal cavity, and (v) sealing, using a second sealing mechanism, the second end of the inflatable tubular envelope to produce the high-altitude balloon having defined therein the inflated internal cavity. The method further includes (vi) separating, using a separating mechanism, the high-altitude balloon from the inflatable tubular envelope dispensed from the buffering subassembly, (vii) displacing, using a conveying assembly, the high-altitude balloon from the separating mechanism, and (viii) launching the high-altitude balloon received from the conveying assembly, the launching being performed from a launch facility co-located with the film production apparatus.

In one embodiment of the present teachings, the method further includes gathering a section of the inflatable tubular envelope adjacent to the second end to define a deflated internal cavity. The deflated internal cavity and the inflated internal cavity are configured to accommodate expansion of the predetermined volume of gas admixture during ascent to a target altitude.

In another embodiment of the present teachings, gathering the section of the inflatable tubular envelope is carried out contemporaneously with dispensing a predetermined volume of gas admixture into the internal cavity.

In yet another embodiment of the present teachings, the buffering subassembly receives the tubular film at a receiving velocity and produces the inflatable tubular envelope at an exiting velocity that is the same as or different than the receiving velocity.

In a further embodiment of the present teachings, during gathering the section of the inflatable tubular envelope, the buffering subassembly produces the inflatable tubular envelope at a reduced exiting velocity.

In another embodiment of the present teachings, sealing the first end of the inflatable tubular envelope includes creating an unsealed portion at the first end by partially sealing the first end. In yet another embodiment of the present teachings, sealing the second end includes sealing the unsealed portion at the first end.

In a further embodiment of the present teachings, separating the high-altitude balloon includes cutting the tubular film using an automated cutting mechanism.

In another embodiment of the present teachings, the balloon launcher is a roof opening.

In yet another embodiment of the present teachings, the method further includes securing the gathered portion of the inflatable tubular envelope with temporary straps.

In a further embodiment of the present teachings, the method further includes controlling, using a controller and based on environmental conditions, mission requirements, and/or flight trajectory predictions, operation of at least one component selected from the group including the film production apparatus, the buffering subassembly, the first sealing mechanism, the second sealing mechanisms, the gas diffuser, the separating mechanism, the conveying assembly, and/or the balloon launcher. The controller controls operation of at least one of the components to manufacture the high-altitude balloon that, when launched, meets mission requirements of target flight path, target altitude, and/or target landing zone.

In another embodiment of the present teachings, the method further includes (a) obtaining two or more tubular films, (b) flattening each of the tubular films to create two or more flattened films, and (c) cutting longitudinally along a length of each flattened film to create two sealable open edges. The method includes (d) unfolding each of the flattened films, and utilizing a first aligning and sealing element including aligning and sealing a first sealable open edge of one of the flattened films with the first sealable open edge of another of the flattened films to form the inflatable tubular envelope. The method further includes (e) utilizing a second aligning and sealing element including aligning and sealing a second sealable open edge of one of the flattened films with a second sealable open edge of another of the flattened films. The first aligning and sealing element and the second aligning and sealing element form the inflatable tubular envelope.

In yet another embodiment of the present teachings, the inflatable tubular envelope is formed by N number of flattened films, where N is an integer greater than or equal to three. The method further includes (a) obtaining N number of tubular films, flattening each of the N tubular films to create N number of flattened films, and (b) cutting longitudinally along a length of each flattened film to create two sealable open edges on each of the N flattened films. The method includes (c) unfolding each of the N flattened films to produce N unfolded film gores, and (d) utilizing N number of aligning and sealing elements to continuously align and seal or fuse adjacent sealable open edges of the N unfolded film gores, thereby forming the inflatable tubular envelope with N longitudinal seams.

The construction and method of operation of the invention, however, together with additional objects and advantages thereof, will be best understood from the following descriptions of specific embodiments when read in connection with the accompanying figures.

### BRIEF DESCRIPTION

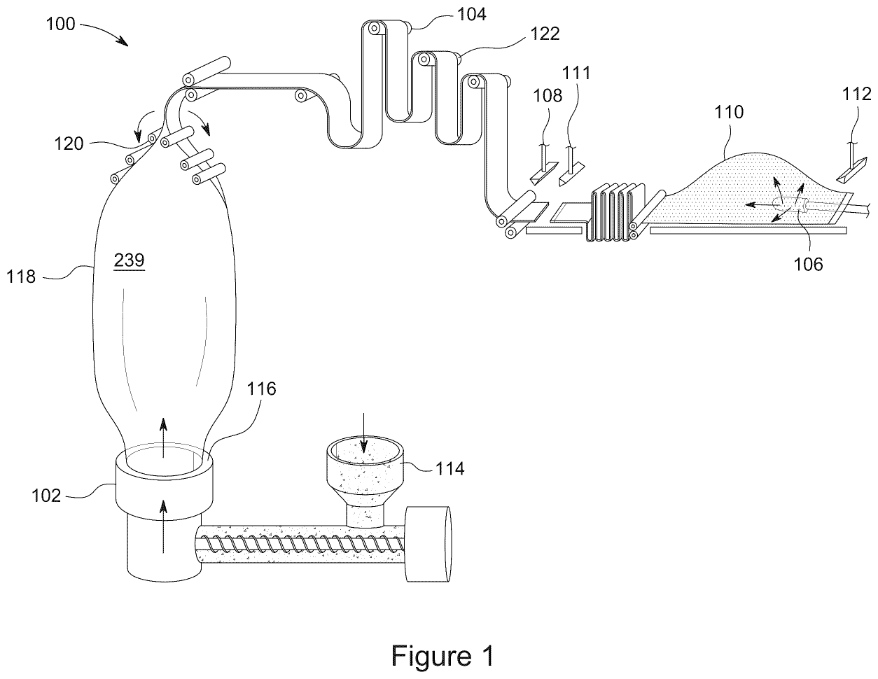

FIG. 1 shows a balloon manufacturing system according to one embodiment of the present arrangements, which provides continuous production of a high-altitude balloon.

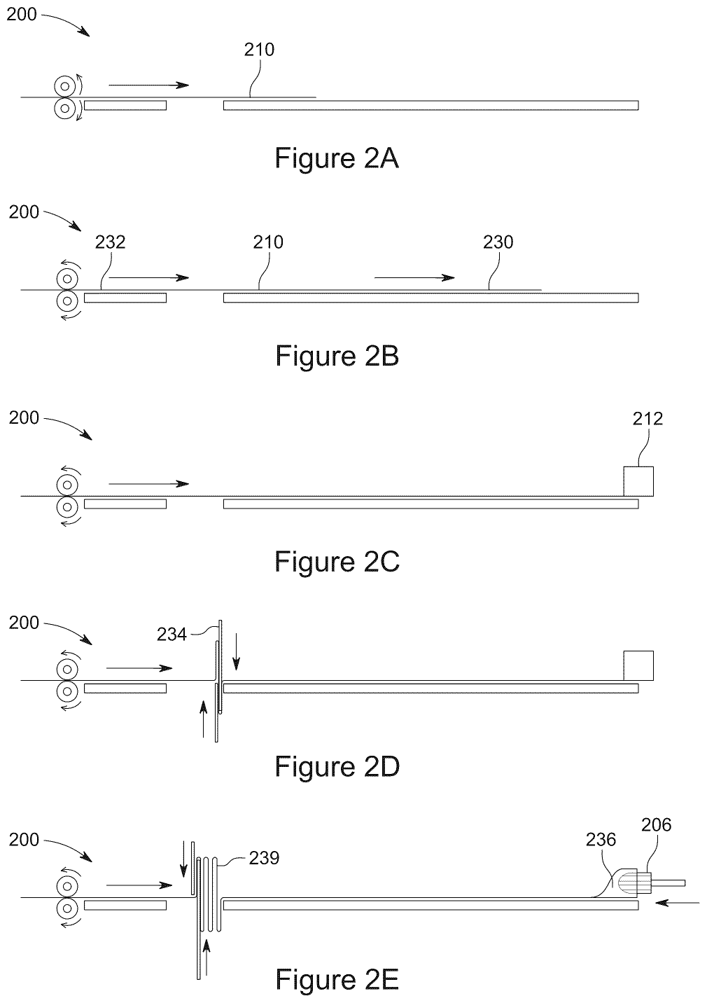

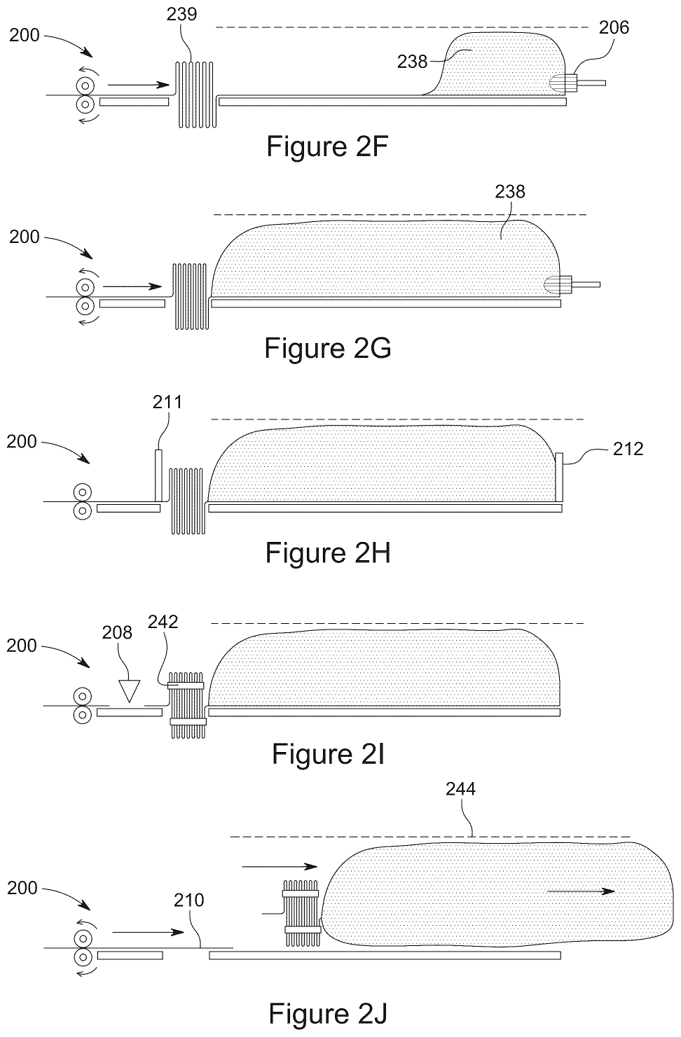

FIG. 2A shows an operative state of the balloon manufacturing system of FIG. 1, according to one embodiment of the present arrangements, in which an inflatable tubular envelope emerges from a buffering subassembly.

FIG. 2B shows another operative state of the balloon manufacturing system of FIG. 1, according to one embodiment of the present arrangements, in which the buffering subassembly continues dispensing inflatable tubular envelope, which includes a first end and a second end.

FIG. 2C shows another operative state of the balloon manufacturing system of FIG. 1, according to one embodiment of the present arrangements, in which a first sealing mechanism creates a partial seal at first end.

FIG. 2D shows another operative state of the balloon manufacturing system of FIG. 1, according to one embodiment of the present arrangements, in which a gathering subassembly gathers a portion of the inflatable tubular envelope at or near the second end.

FIG. 2E shows another operative state of the balloon manufacturing system of FIG. 1, according to one embodiment of the present arrangements, in which a gas diffuser is inserted, through the unsealed portion of first end, into the internal cavity.

FIG. 2F shows another operative state of the balloon manufacturing system of FIG. 1, according to one embodiment of the present arrangements, in which the gas diffuser forms an inflated internal cavity at or near the first end and the gathering subassembly creates a deflated internal cavity at or near the second end.

FIG. 2G shows another operative state of the balloon manufacturing system of FIG. 1, according to one embodiment of the present arrangements, in which inflated internal cavity expands to accommodate the full predetermined volume of gas admixture.

FIG. 2H shows another operative state of the balloon manufacturing system of FIG. 1, according to one embodiment of the present arrangements, in which a first sealing mechanism seals the first end and a second sealing mechanism seals the second end.

FIG. 2I shows another operative state of the balloon manufacturing system of FIG. 1, according to one embodiment of the present arrangements, in which a separating mechanism separates the high-altitude balloon from the inflatable tubular envelope.

FIG. 2J shows another operative state of the balloon manufacturing system of FIG. 1, according to one embodiment of the present arrangements, in which conveying assembly moves the completed high-altitude balloon toward a launch system.

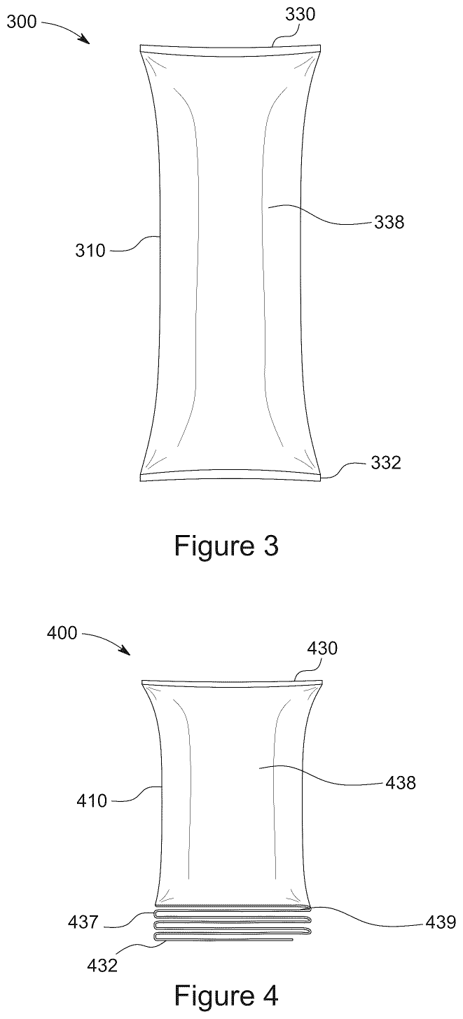

FIG. 3 shows a high-altitude balloon, according to one embodiment of the present arrangements, that has defined therein an inflated internal cavity extending from a sealed first end and a sealed second end.

FIG. 4 shows a high-altitude balloon, according to another embodiment of the present arrangements, that includes an inflatable tubular envelope having an inflated internal cavity and a deflated internal cavity.

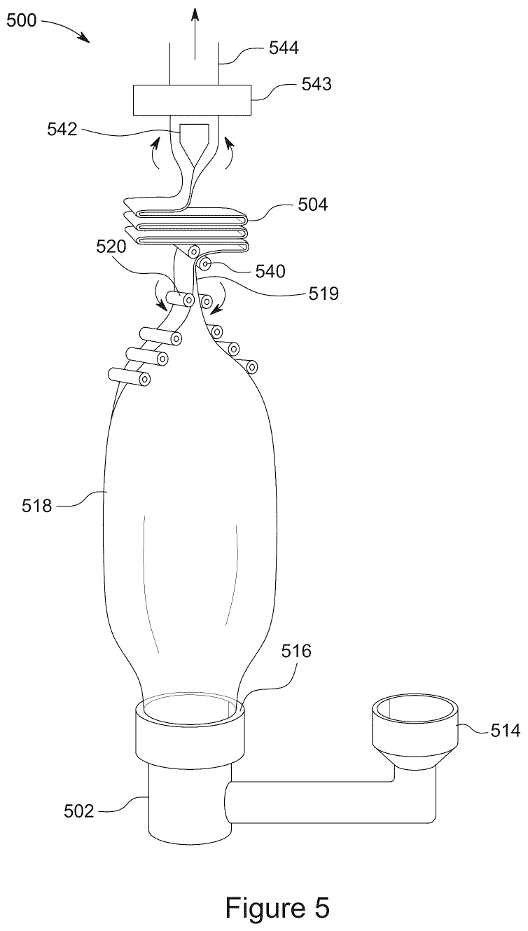

FIG. 5 shows single gore manufacturing subsystem according to one embodiment of the present arrangements for manufacturing multi-gore balloons.

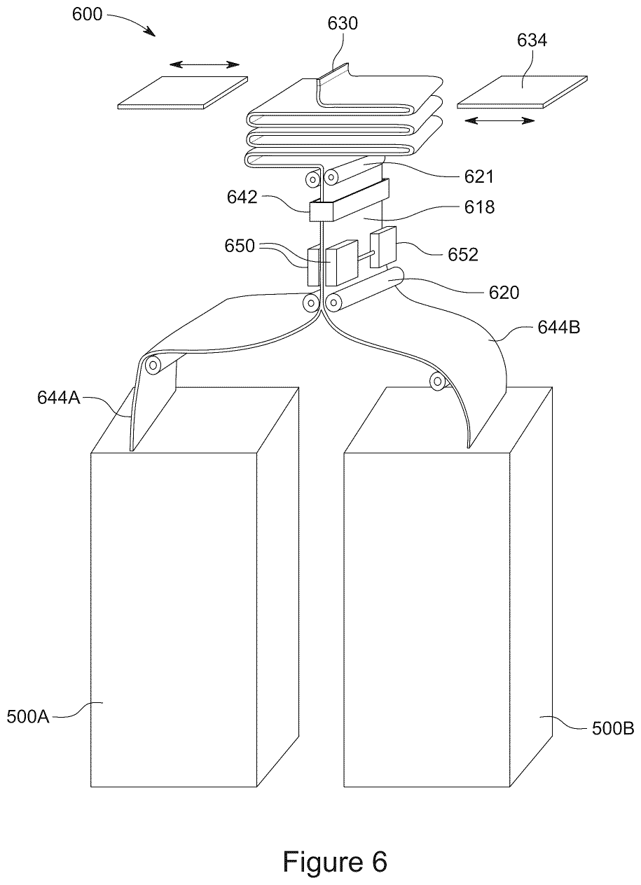

FIG. 6 shows multi-gore balloon manufacturing system, according to one embodiment of the present arrangements, that includes two single gore manufacturing subsystems for continuous manufacture of multi-gore balloons.

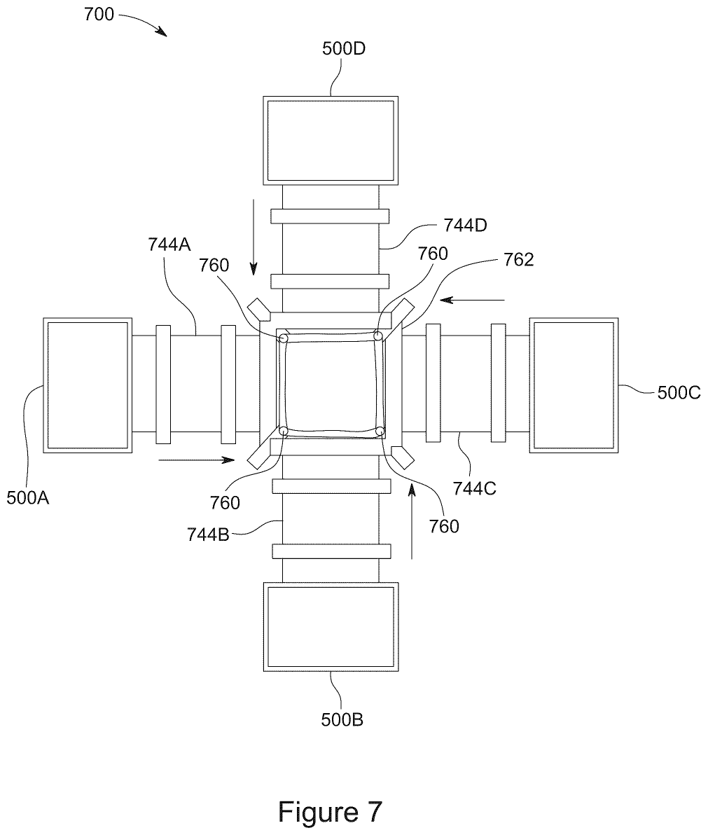

FIG. 7 shows a four-gore balloon manufacturing system, according to one embodiment of the present arrangements, that includes four single gore manufacturing subsystems for continuous manufacture of multi-gore balloons.

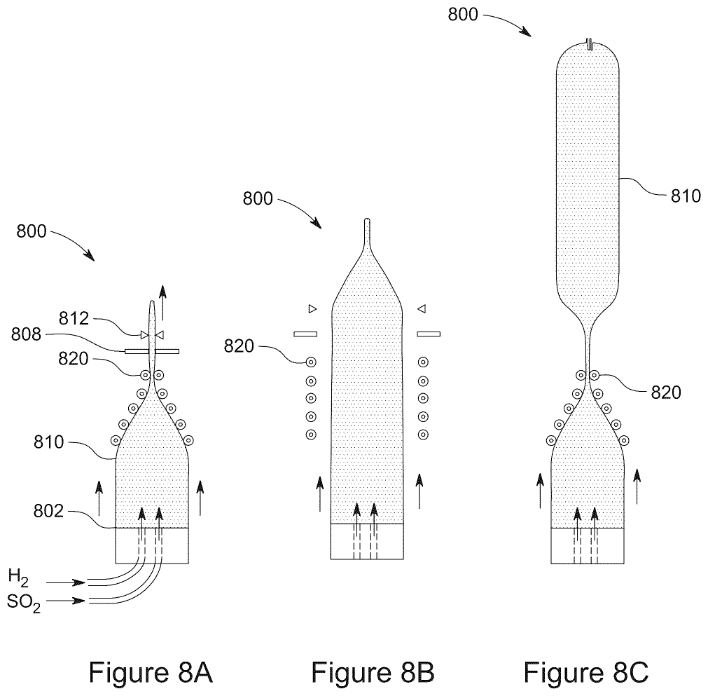

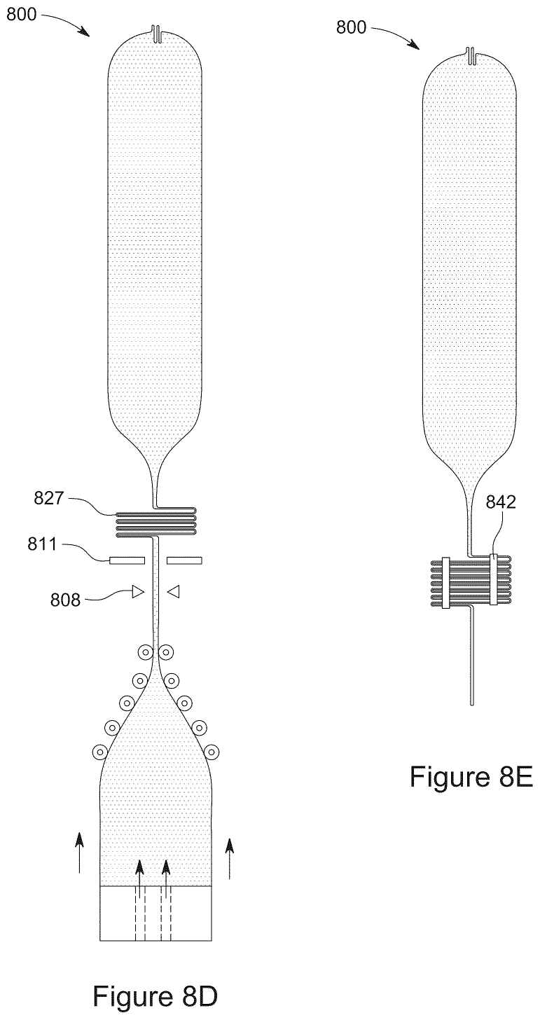

FIG. 8A shows an operative state of direct fill manufacturing system, according to one embodiment of the present arrangements, in which a gas admixture that includes a lifting gas and a payload (e.g., an aerosol gas) are used by a film production apparatus creates and fills an inflatable tubular envelope.

FIG. 8B shows another operative state of direct fill manufacturing system, according to one embodiment of the present arrangements, in which one or more nip rollers are disengaged and film production apparatus continues producing inflatable tubular envelope and the admixed gas continues to fill the inflatable tubular envelope.

FIG. 8C shows another operative state of direct fill manufacturing system, according to one embodiment of the present arrangements, in which one or more nip rollers are re-engaged to flatten a portion of the inflatable tubular envelope and prevent the gas admixture from further inflation of the inflated internal cavity and form another deflated internal cavity.

FIG. 8D shows another operative state of direct fill manufacturing system, according to one embodiment of the present arrangements, in which gathering subassembly gathers the deflated internal cavity to form a gathered portion.

FIG. 8E shows an operative state of direct fill manufacturing system, according to one embodiment of the present arrangements, in which the direct fill balloon is sealed and detached from the inflatable tubular envelope.

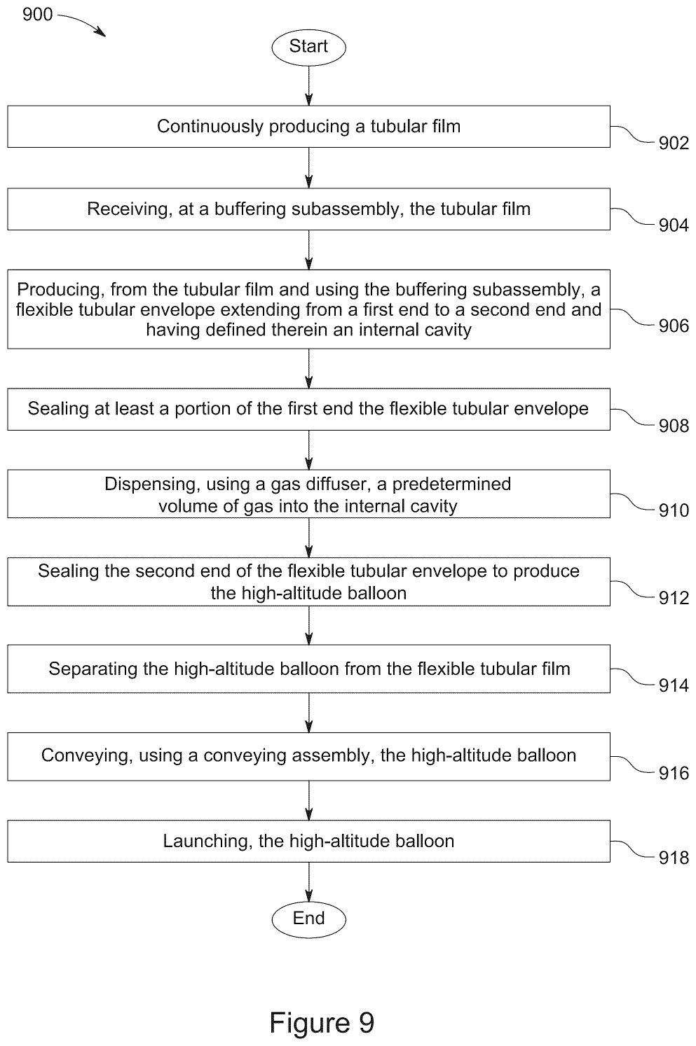

FIG. 9 shows a method of continuous manufacture and launch of high-altitude balloon, according to one embodiment of the present teachings.

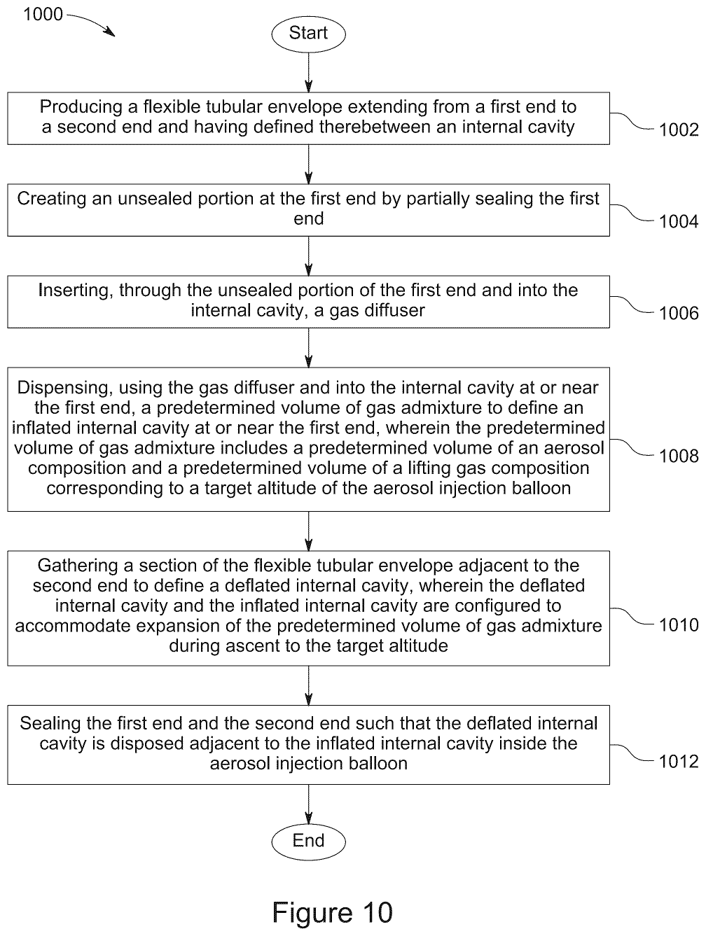

FIG. 10 shows a method of continuous manufacture and launch of an aerosol balloon, according to one embodiment of the present teachings.

### DETAILED DESCRIPTION

In the following description, numerous specific details are set forth in order to provide a thorough understanding of the present invention. It will be apparent, however, to one skilled in the art that the present invention may be practiced without limitation to some or all of these specific details. In other instances, well known process elements have not been described in detail in order to not unnecessarily obscure the invention.

The present arrangements generally relate to a novel and highly efficient system for the continuous manufacture, filling, and launch of high-altitude balloons. Traditionally, balloon manufacturing, filling, and launching are separate processes that require significant logistical coordination and transportation. This is particularly true for large-scale operations, where balloons are often manufactured at a centralized facility, shipped to a launch site, and then filled and launched. This segmented approach introduces costs, complexities, and potential for damage during transit and handling. The balloon's payload, such as a gaseous substance, may also be transported separately to the launch site, adding another layer of logistical and financial burden. What is needed is a streamlined, integrated system that eliminates these inefficiencies by combining the entire process into a single, automated facility.

The present systems and methods provide a comprehensive solution to these challenges. By situating all production steps on-site and in-line, the system reduces external transportation, storage, and handling, which in turn significantly lowers operational costs and mitigates the risks associated with moving delicate film and filled envelopes. This approach enables real-time optimization of manufacturing parameters based on environmental data, weather conditions, and mission requirements. As a result, balloon parameters, e.g., balloon film thickness, balloon volume, gas composition, and gas fill volume, may be continually adjusted to ensure the balloon meets mission requirements such as target flight path, target altitude, and target landing zone.

The present teachings and arrangements described below may be useful in the manufacturing of balloons for stratospheric aerosol injection (SAI). The high cost of using balloons for SAI, which has been a point of criticism in the known art, can be overcome by the efficiencies of the present system. For example, the system can produce a balloon where the fill gas includes a lifting gas and a payload in the form of a liquid, gas, and/or solid, and the process can be adjusted to optimize the balloon's flight and ascent profile. This integrated approach to manufacturing and launching allows for an economically efficient and scalable solution for stratospheric delivery, regardless of the specific payload.

FIG. 1 shows a balloon manufacturing system 100 according to one embodiment of the present arrangements, which provides continuous production of high-altitude balloons. Balloon manufacturing system 100 includes a film production apparatus 102 that continuously produces tubular film 118. In one embodiment of the present arrangements, film production apparatus 102 includes an extruder 114 and a film blower 116. Plastic pellets, which serve as the plastic input, are loaded into extruder 114, which melts the pellets. The molten plastic is fed into film blower 116, which extrudes the molten plastic through a die to form tubular film 118

A roller assembly 120 is communicatively coupled to film production apparatus 102. As tubular film 118 rises from film production apparatus 102, tubular film 118 is guided into roller assembly 120, which collapses tubular film 118. In one embodiment of the present arrangements, roller assembly 120 flattens tubular film 118 into a flattened, two-layer film. The tubular film 118 then enters a buffering subassembly 104.

Buffering subassembly 104 receives tubular film 118 and produces an inflatable tubular envelope 110 that extends from a first end to a second end. Moreover, buffering subassembly 104 serves as an intermediary that manages film flow rates between the continuous extrusion process and downstream balloon assembly operations. In one embodiment of the present teachings, buffering subassembly 104 includes a series of horizontal rollers 122 that temporarily accumulate and store a length of tubular film 118. Buffering subassembly 104 collects tubular film 118 at a receiving velocity and distributes inflatable tubular envelope 110 at an exiting velocity that may be the same or different than the receiving velocity, allowing the continuous production of tubular film 118 to proceed even if downstream processes temporarily slow down or pause.

First sealing mechanism 112 and second sealing mechanism 111 are positioned to at least partially seal the first end and the second end of inflatable tubular envelope 110, respectively. Gas diffuser 106 dispenses a gas admixture, obtained from a gas admixture reservoir, into an internal cavity defined within inflatable tubular envelope 110 between the first end and second end. In one embodiment of the present arrangements, the second end is sealed, and gas diffuser 106 is inserted into the internal cavity through the first end. Upon completion of gas infusion, second sealing mechanism 111 seals the second end. In another embodiment of the present arrangements, the first end is partially sealed to create an unsealed portion of the first end. Gas diffuser 106 is inserted into the unsealed portion and upon completion of gas infusion, the unsealed portion is sealed.

Film production apparatus 102 may be any apparatus that produces tubular film 118, for example, a film blower, caster, flat die extruder, laminator, or co-extruder. In one embodiment of the present teachings, tubular film 118 is made of latex and/or a latex composite. Film production apparatus 102 may include a mold and a dipper.

Tubular film 118 and/or the inflatable tubular envelope 110 may be made from at least one material selected from a group comprising latex, linear low-density polyethylene, polyethylene, polyamide, polyethylene terephthalate (PET), biaxially oriented polyethylene terephthalate (Bopper), ethylene-vinyl acetate (EVA), and polyvinylidene chloride (PVDC).

In one embodiment of the present arrangements, tubular film 118 and/or the inflatable tubular envelope 110 have a sidewall thickness that ranges from between about 0.5 micrometers and about 100 micrometers. In a preferred embodiment of the present arrangements, tubular film 118 and/or the inflatable tubular envelope have a sidewall thickness that ranges from between about 3 micrometers and about 40 micrometers. In a more preferred embodiment of the present arrangements, tubular film 118 and/or the inflatable tubular envelope have a sidewall thickness that ranges from between about 5 micrometers and about 20 micrometers.

Separating mechanism 108 severs the completed balloon envelope from the continuous film stream, enabling individual balloon production while maintaining continuous operation of the upstream film production components. First sealing mechanism 112 may employ heat sealing, ultrasonic welding, or similar techniques known in the art to create strong, gas-tight closures that maintain balloon integrity during inflation and flight.

FIG. 2A, FIG. 2B, FIG. 2C, FIG. 2D, FIG. 2E, FIG. 2F, FIG. 2G, FIG. 2H, FIG. 2I, and FIG. 2J shows a balloon manufacturing system 200 according to one embodiment of the present arrangements. Balloon manufacturing system 200, which is substantially similar to balloon manufacturing system 100 of FIG. 1. FIGS. 2A-2J show a sequential view of how inflatable tubular envelope 210 progresses through different operative states following displacement from a buffering subassembly (e.g., buffering subassembly 104 of FIG. 1).

FIG. 2A shows balloon manufacturing system 200 according to one operative state of the present arrangements where inflatable tubular envelope 210 emerges from the buffering subassembly. In this implementation of the present arrangements, inflatable tubular envelope 210 is positioned horizontally along a platform. However, the present teachings are not so limited. Inflatable tubular envelope 210, dispensed from the buffering subassembly, may extend vertically. One or more nip rollers and/or the buffering assembly maintain inflatable tubular envelope 210 in the vertical orientation during the proceeding manufacturing stages.

As shown in FIG. 2B, inflatable tubular envelope 210 extends from a first end 230 to a second end 232 in another operative state of balloon manufacturing system 200. First end 230 and second end 232 define a boundary of the internal cavity that will contain the gas admixture. Inflatable tubular envelope 210 maintains its tubular configuration with both ends remaining open at this stage to facilitate subsequent sealing and gas injection operations.

FIG. 2C shows balloon manufacturing system 200 according to one operative state of the present arrangements, where a first sealing mechanism 212 creates a partial seal at first end 230. The partial sealing creates an unsealed portion at the first end to accommodate gas diffuser insertion. First sealing mechanism 212 uses at least one sealing technique selected from a group comprising heat sealing, cold sealing, laser sealing, impulse continuous band sealing, impulse continuous wheel sealing, radio frequency welding, or vertical form fill sealing to create a strong, gas-tight closure while maintaining the unsealed portion for gas injection access.

A balloon manufacturing system 200 according to one operative state of the present arrangements, shown in FIG. 2D, shows gathering subassembly 234 gathering inflatable tubular envelope 210 adjacent to second end 232. Gathering subassembly 234 creates controlled folds or gathers in the envelope material. A Z-fold or accordion fold may be used to gather inflatable tubular envelope 210 such that multiple portions of the inflatable tubular envelope 210, when folded, are adjacent to other folded portions. By way of example, a gathering apparatus 234 may be pushed against a top surface of inflatable tubular envelope 210 to create a fold line extending between opposing sidewalls and moving a portion of inflatable tubular envelope 210 downward into a vertical orientation. Another second folding apparatus may be pushed against the bottom surface of inflatable tubular envelope 210, moving another portion of inflatable tubular envelope 210 upward into the vertical orientation. The vertically oriented portions of inflatable tubular envelope 210 are proximate to one another to create a deflated internal cavity 239. This gathering process creates excess material that will accommodate gas expansion during balloon ascent. In another embodiment, the gathering operation involves rolling inflatable tubular envelope 210 to create a cylindrical bundle.

FIG. 2E shows balloon manufacturing system 200 according to one operative state of the present arrangements, the insertion of gas diffuser 206 through the unsealed portion of first end 230 into internal cavity 236. Gas diffuser 206, coupled to a gas admixture reservoir, dispenses a predetermined volume of gas admixture, as shown in FIG. 2F, to create an inflated internal cavity 238. Inflated internal cavity 238 forms at or near first end 230 as gas diffuser 206 introduces the predetermined volume of gas admixture.

Gas admixture, in one embodiment of the present arrangements, may be a lifting gas that includes at least one lifting gas selected from a group comprising helium, hydrogen, coal gas, ammonia, and methane. Gas admixture may also include at least one aerosol composition. The aerosol composition may be any solid, liquid and/or gas that is added to the lifting gas. In one embodiment of the present arrangements, the gas admixture includes at least one aerosol composition selected from a group comprising SO₂, H₂S, H₂SO₄, H₂, OCS, CaCO₂, AlO, Al₂O₂, Al₂O₃, SiO₂, TiO₂, solid sulfur, diamond dust, and black carbon. The aerosol type may include a gas, liquid, and/or a solid. The solid, when released into the atmosphere, has radiation-blocking characteristics that reflect and/or block solar radiation.

The aerosol type, in one embodiment of the present arrangements, has a particle diameter that ranges from between about 0.0001 micrometers and about 10 micrometers. In a preferred embodiment of the present arrangements, the aerosol type has a particle diameter that ranges from between about 0.00036 micrometers and about 2 micrometers. In a preferred embodiment of the present arrangements, the aerosol type has a particle diameter that ranges from between about 0.15 micrometers and about 0.35 micrometers.

The gathering process, described above in FIGS. 2D-2F , creates a gathered portion 227 of inflatable tubular envelope 210. Deflated internal cavity 239, shown in FIG. 2F, within the gathered portion 227 of inflatable tubular envelope 210, remains adjacent to second end 232. The inflated internal cavity 238 and deflated internal cavity 239 accommodates volumetric expansion of the gas admixture under decreasing atmospheric pressure during ascent to the target altitude.

FIG. 2G shows balloon manufacturing system 200 according to one operative state of the present arrangements, continued inflation, where inflated internal cavity 238 expands to accommodate the full predetermined volume of gas admixture. The inflation may include preheating or precooling of the gas admixture to optimize balloon buoyancy and ascent profile, or ionization to reduce static charge buildup on the envelope material. Deflated internal cavity 239 remains collapsed, providing expansion capacity for altitude-induced gas expansion.

First sealing mechanism 212 and second sealing mechanism 211, as shown in FIG. 2H, seal both ends of the inflatable tubular envelope 210. First sealing mechanism 212 completes the seal of first end 230 after removal of gas diffuser 206 from the unsealed portion. Second sealing mechanism 211 seals second end 232, creating a hermetically sealed balloon envelope. Gathered portion 237, which is adjacent to second end 232, forms a deflated internal cavity 239.

Separating mechanism 208 of balloon manufacturing system 200, according to one operative state of the present arrangements as shown in FIG. 2I, severs the completed balloon envelope from inflatable tubular envelope 210. The separating mechanism employs slitting roller blades, scissor blades, laser cutters, or knife blades to cleanly separate the balloon while maintaining structural integrity. Temporary straps 242, or other mans of securement such as a bag or heat welds between layers, are applied to secure gathered portion 237, preventing uncontrolled expansion of the deflated internal cavity during handling, launch preparation and early ascent. These temporary straps are configured to release during balloon expansion at altitude.

FIG. 2J shows balloon manufacturing system 200, according to one operative state of the present arrangements, in which conveying assembly 244 moves the completed high-altitude balloon toward a launch system. Conveying assembly 244 may include air blowers to push and guide the high-altitude balloon without physical contact between the conveyance mechanism and the high-altitude balloon. This non-contact conveying method prevents damage to the high-altitude balloon envelope while directing it toward the balloon launcher, which may be integrated as a roof opening in the manufacturing facility.

FIG. 3 shows a high-altitude balloon 300, according to one embodiment of the present arrangements, that includes an inflatable tubular envelope 310 extending from a sealed first end 330 and a sealed second end 332. Inflatable tubular envelope 310 has defined therein an inflated internal cavity 338 defined between a first end 330 and a second end 332. In a deflated state, high-altitude balloon 300 may have a uniform internal diameter from the first end to the second end or the internal diameter may have a predetermined variation from the first end to the second end.

The cylindrical or tubular configuration of high-altitude balloon 300 offers several design advantages over conventional spherical balloon geometries. This cylindrical shape simplifies the manufacturing process by allowing continuous production from tubular film (e.g., tubular film 118 of FIG. 1) without requiring complex pattern cutting or assembly operations. Similarly, a uniform diameter along the balloon length may enable more aerodynamic forms and may improve envelope strength by controlling tension concentration at sharp corners. This cylindrical shape also simplifies the sealing operations at the first end and the second end, is more compatible with existing conveyance systems, and, due to increased ease of automation, is less prone to damage due to handling, which is a primary cause of failure for high altitude balloons.

FIG. 4 shows a high-altitude balloon 400, according to another embodiment of the present arrangements, that includes an inflatable tubular envelope 410 having an inflated internal cavity 438 and a deflated internal cavity 439. Inflated internal cavity 438 is located at or near a first end 430 and contains a gas admixture. The gas admixture includes a lifting gas composition or a lifting gas composition and an aerosol composition. A volume of lifting gas composition corresponds to a predetermined target altitude.

A gathered portion 427 of inflatable tubular envelope 410 is adjacent to a second end 432 and defines a deflated internal cavity 439. Preferably, gathered portion 427 is secured with temporary straps (e.g., temporary straps 242 of FIG. 2I).

This embodiment of the present arrangements allows high-altitude balloon 400 to ascend in a compact, manageable form and reduces the risk of collision for inflatable tubular envelope 410 during the initial stage of ascent. Collision with obstacles near the ground is a common source of failure for high altitude balloon launches and risk of collision places significant limits on acceptable weather conditions at launch. Gathering and securing deflated internal cavity 439 significantly reduces this risk and increases the window of acceptable launch conditions without the complex and heavy control mechanisms conventionally deployed to address this problem. The inflated and deflated sections are engineered to accommodate the volumetric expansion of the gas as high-altitude balloon 400 rises through decreasing atmospheric pressure. Once high-altitude balloon 400 reaches its target altitude, the continued expansion of the gas exceeds the combined capacity of both inflated internal cavity 438 and a deflated internal cavity 439, causing high-altitude balloon 400 to rupture and disperse its payload.

Inflatable tubular envelope 410 and/or the tubular film (e.g., tubular film 118 of FIG. 1) may be reinforced with polymer fibers embedded during production to enhance tear resistance and puncture resistance.

In one embodiment of the present arrangements, the internal cavity of high-altitude balloon 400 has a diameter that ranges from between about 1 meter and about 75 meters. In a preferred embodiment of the present arrangements, high-altitude balloon 400 of an internal diameter that ranges from between about 2 meters and about 30 meters. In a preferred embodiment of the present arrangements, high-altitude balloon 400 of an internal diameter that ranges from between about 3 meters and about 6 meters.

The present teachings and arrangements recognize constraints to manufacturing single gore high-altitude balloons having larger diameters. By way of example, single gore high-altitude balloon size may be limited by the maximum diameter of the film produced by a single blowing machine, typically ranging between 2 meters and 4 meters. To overcome these manufacturing constraints, the present arrangements and teachings offer systems and methods for the continuous manufacture of multi-gore high-altitude balloons. Multi-gore balloon manufacturing enables the production of larger balloon envelopes with improved mass efficiency by achieving a smaller length-to-diameter ratio for a given envelope volume.

FIG. 5 shows single gore manufacturing subsystem 500 according to one embodiment of the present arrangements for manufacturing multi-gore balloons. Multiple single gore manufacturing subsystems 500 are used to manufacture multi-gore high-altitude balloons. To this end, single gore manufacturing subsystem 500 represents one of multiple parallel manufacturing units that operate simultaneously to produce individual film gores that are subsequently joined together to create larger-diameter balloon envelopes exceeding the size limitations of single-gore cylindrical balloons.

Single gore manufacturing subsystem 500 includes a film production apparatus 502, buffering subassembly 504, roller assembly 520, which may include one or more nip rollers, an edge cutter 540, and an unfolding apparatus 542.

Film production apparatus 502 produces a tubular film 518. In one implementation of the present arrangements, film production apparatus 502 includes an extruder 514 and a film blower 516. As discussed above, extruder 514 receives polymer feedstock, typically linear low-density polyethylene pellets, and melts the polymer to create a homogeneous molten stream. The molten polymer is fed to film blower 516, which extrudes the material through an annular die to form continuous tubular film 518.

Unlike single-gore manufacturing processes that preserve the tubular geometry, the multi-gore process converts tubular film 518 into an unfolded film 544 (e.g., a parallelogram-shaped film) for subsequent processing. To create unfolded film 544, tubular film 518 passes through roller assembly 520, which flatten tubular film 518 to produce a flattened film 519 having two substantially parallel flattened edges. Thus, tubular film 518 transitions from a cylindrical shape into a lay-flat configuration. This flattening operation is followed by edge cutter 540, which performs a longitudinal cut along one edge of flattened film 519, transforming the collapsed cylinder into a C-shaped folded film having two sealable open edges. This cutting operation converts continuous tubular film 518 into a flat sheet that can be processed and joined with other similar sheets. Unfolding apparatus 542 unfolds the folded film to create unfolded film 544

Buffering subassembly 504 functions as a buffer and process control mechanism, similar to the buffering subassembly described in previous figures (e.g., buffering subassembly 104 of FIG. 1), by managing the flow rate of tubular film 518 production and enabling variations in downstream processing speeds. Buffering subassembly 504 enables the single gore manufacturing subsystem 500 to operate continuously while downstream multi-gore assembly processes, discussed in greater detail below, proceed at different velocities. By way of example, an ability to adjust the velocities of each single gore manufacturing subsystem 500 enables multiple unfolded sheets 554 to be precisely aligned and transmitted through sealing equipment to create the multi-gore high-altitude balloon.

In one embodiment of the present arrangements, unfolded film 544 proceeds through a film processor 543, which can add coatings or adjust polymer cross-linking.

FIG. 6 shows a multi-gore balloon manufacturing system 600 according to one embodiment of the present arrangements for continuous manufacture of multi-gore balloons. Multi-gore balloon manufacturing system 600 coordinates the output from first single gore manufacturing subsystem 500A and second single gore manufacturing subsystem 500B to create larger balloon envelopes. This parallel processing approach enables production of high-altitude balloons exceeding the size limitations of single-gore balloons while maintaining the manufacturing efficiency of continuous film production.

First single gore manufacturing subsystem 500A and second single gore manufacturing subsystem 500B are substantially similar to single gore manufacturing subsystem 500 of FIG. 5. First single gore manufacturing subsystem 500A and second single gore manufacturing subsystem 500B operate in parallel to produce first unfolded film 644A and second unfolded film 644B, respectively.

A first aligning and sealing element and a second aligning and sealing element align and seal first unfolded film 644A and second unfolded film 644B to form the inflatable tubular envelope. For example one or more alignment nip rollers 620, bring together first unfolded film 644A and second unfolded film 644B and ensure sealable open edges of first unfolded film 644A align with corresponding sealable open edges of second unfolded film 644B. Additionally, one or more alignment nip rollers 620 and one or more tension control rollers 621 ensure first unfolded film 644A and second unfolded film 644B are appropriately tensioned and move at a velocity that ensures edge sealing or fusion. In another embodiment of the present arrangements, one or more alignment nip rollers 620 and one or more tension control rollers 621 may be replaced and/or augmented with other film handling systems, including but not limited to an idler, guide roller, vacuum roller, vacuum drum, vacuum conveyor, pivot-frame edge, and displacement guide.

Another portion of the first aligning and sealing element, for example first edge sealer 650, seals or fuses together a first sealable open edge of first unfolded film 644A and the first sealable open edge of second unfolded film 644B. A second aligning and sealing element, for example second edge sealer 652, seals or fuses together the second sealable open edge of first unfolded film 644A and the second sealable open edge of second unfolded film 644B to form a multi-gore tubular film 618. Multi-gore tubular film 618 has defined therein an internal cavity extending between the first sealed edge and the second sealed edge.

An optional film processor 642 can perform additional processing on the multi-gore tubular film 618, such as adding coatings or adjusting the polymer's cross-linking to change chemical and/or physical properties.

A gathering subassembly 634 then gathers multi-gore tubular film 618 to produce a gathered portion. By incorporating a gathered portion, the manufacturing footprint of multi-gore tubular film 618 is reduced. The multi-gore tubular film 618 with the gathered portion may be used in downstream processing, for example, gas admixture fill, sealing, and launching.

In one embodiment of the present arrangements, a sealing mechanism (e.g., first sealing mechanism of FIG. 1) seals a first end 630 of multi-gore tubular film 618.

FIG. 7 shows a four-gore balloon manufacturing system 700 according to another embodiment of the present arrangements, demonstrating an expanded configuration for manufacturing large-diameter high-altitude balloons through a multi-gore balloon manufacturing system. This system extends the multi-gore manufacturing approach beyond the two-gore configuration by integrating four parallel single gore manufacturing subsystems arranged in a radial or orthogonal pattern around a central sealing assembly 762. The four-gore configuration enables production of balloon envelopes with substantially larger diameters than what is achievable with two-gore balloon manufacturing systems, further overcoming the fundamental size constraints imposed by individual film blowing machine annulus diameters.

Four-gore balloon manufacturing system 700 includes single gore manufacturing subsystem 500A, single gore manufacturing subsystem 500B, single gore manufacturing subsystem 500C, and single gore manufacturing subsystem 500D, each operating simultaneously to produce unfolded film 744A, unfolded film 744, unfolded film 744C, and unfolded film 744D, respectively. Each single gore manufacturing subsystem is substantially similar to the single gore manufacturing subsystem 500 of FIG. 5.

Unfolded films 744A, 744B, 744C, and 744D converge at central sealing assembly 762, where alignment mechanisms (e.g., one or more alignment nip rollers 620 of FIG. 6 and/or buffering subassembly 504 of FIG. 5) ensure proper edge-to-edge positioning for the sealing operations. The alignment system coordinates the film velocities and tensions from all four subsystems to maintain consistent positioning throughout the continuous manufacturing process.

Edge sealer 760 creates an extending edge sealing or fusion between adjacent unfolded films 744A, 744B, 744C, and 744D. Central sealing assembly 762 shown in FIG. 7 demonstrates a centralized sealing approach where multiple edge sealers 760 operate simultaneously or sequentially to join the four individual unfolded films into a unified inflatable tubular envelope.

Each edge sealer 760 aligns and seals or fuses extending edges of adjacent unfolded films, fusing unfolded film 744A to unfolded film 744B along one edge, unfolded film 744B to unfolded film 744C along another edge, unfolded film 744C to unfolded film 744D along a third edge, and unfolded film 744D back to unfolded film 744A to complete the inflatable tubular envelope.

The present arrangements and teachings are not limited to two and four-gore inflatable tubular envelopes. The inflatable tubular envelope may be formed by N number of flattened films, where N is an integer greater than or equal to 3. The method includes obtaining N number of tubular films and flattening each of the tubular films to create N number of flattened films. Another element includes cutting longitudinally along a length of each flattened film to create two sealable open edges on each of the N flattened films. Next, an element includes unfolding each of the flattened films to produce N unfolded film gores. Finally, a utilizing element includes utilizing N number of aligning and sealing elements to continuously align and seal or fuse all adjacent sealable open edges of the N unfolded film gores, thereby forming the inflatable tubular envelope with N longitudinal seams.

FIG. 8A, FIG. 8B, FIG. 8C, FIG. 8D, and FIG. 8E show a direct fill manufacturing system 800 according to one embodiment of the present arrangements that integrates the creation of an inflatable tubular envelope with the act of filling the inflatable tubular envelope with a gas admixture. Direct fill manufacturing system 800 eliminates a separate gas injection step after the envelope has been formed. FIGS. 8A-8E show different operative states of direct fill manufacturing system 800.

FIG. 8A shows an operative state of direct fill manufacturing system 800 in which film production apparatus 802 is activated to create an inflatable tubular envelope 810. A gas admixture, which includes a volume of a lifting gas composition, e.g., H₂ and, in one implementation of the present arrangements, a volume of an aerosol composition in liquid, gas and/or solid form, e.g., SO₂, is used to form and inflate an internal cavity of inflatable tubular envelope 810. The gas admixture also cools inflatable tubular envelope 810 as it is being formed. The inflated portion defined within inflatable tubular envelope 810 is referred to as an inflated internal cavity. A sealing mechanism 812 forms a leading transverse seal across the inflatable tubular envelope 810, while a separating mechanism 808 cuts away excess film. One or more nip rollers 820 are engaged to flatten a portion of inflatable tubular envelope 810 to create a deflated internal cavity and to prevent or reduce escape of the gas admixture from inflatable tubular envelope 810.

FIG. 8B shows another operative state of direct fill manufacturing system 800 in which film production apparatus 802 continues producing inflatable tubular envelope 810 and the admixed gas continues to fill inflatable tubular envelope 810. Separating mechanism 808, sealing mechanism 812, and one or more nip rollers 820 are in a retracted position to allow the admixed gas to inflate the deflated internal cavity of inflatable tubular envelope 810.

FIG. 8C shows yet another operative state of direct fill manufacturing system 800 in which one or more nip rollers 820 are re-engaged to flatten a portion of inflatable tubular envelope 810 and prevent the gas admixture from further inflation of the inflated internal cavity and form another deflated internal cavity.

FIG. 8D shows yet another operative state of direct fill manufacturing system 800 in which gathering subassembly gathers the deflated internal cavity to form a gathered portion 827. With the inflated portion held static by the nip rollers, the gathering subassembly 834 folds the continuing film production into a Z-fold or accordion bundle below the inflated internal cavity. A sealing mechanism 811 and a separating mechanism 808 are positioned to make the final seal and cut inflatable tubular envelope 810 when a desired direct fill balloon length is reached. Production apparatus 802 continues to create inflatable tubular envelope 810 for production of another direct fill balloon.

As shown in FIG. 8E, temporary straps 842 are secured around gathered portion 827. The completed direct fill balloon is now ready to be moved by a conveying assembly to a launcher.

The present teachings offer, among other things, different methods of continuous manufacture and launch of high-altitude balloons. FIG. 9 shows a method of continuous manufacture and launch of high-altitude balloon 900, according to one embodiment of the present teachings. Method 900 begins with an element 902, which includes continuously producing a tubular film. This can be accomplished by a film production apparatus (e.g., film production apparatus 102 of FIG. 1). In one embodiment of the present teachings, the film production apparatus includes an extruder (extruder 114 of FIG. 1) and a film blower (e.g., a film blower 116 of FIG. 1). The extruder melts plastic pellets and extrudes the molten plastic through a film blower to form the tubular film (e.g., tubular film 118 of FIG. 1).

Method 900 then proceeds to element 904, which includes receiving the tubular film at a buffering subassembly. The buffering subassembly (e.g., buffering subassembly 104 of FIG. 1) collects the continuously produced tubular film at a receiving velocity and distributes the tubular film at an exiting velocity that can be the same as or different than the receiving velocity. This allows for the continuous production of the tubular film to proceed even if downstream processes temporarily slow down or pause. In one embodiment of the present teachings, the buffering subassembly includes one or more tension accumulators configured to maintain tubular film tension during variable exiting velocity. The one or more tension accumulators also gather excess tubular film when the receiving velocity is greater than the exiting velocity and dispense the gathered tubular film when the exiting velocity is greater than the receiving velocity.

Next, element 906 is carried out. Element 906 includes producing, from the tubular film and using the buffering subassembly, an inflatable tubular envelope (e.g., inflatable tubular envelope 210 of FIG. 2A) that has an internal cavity and extends from a first end (e.g., first end 230 of FIG. 2B) to a second end (e.g., second end 232 of FIG. 2B). In one embodiment of the present teachings, the first end is a leading end of the inflatable tubular envelope (i.e., end that is away from the buffering subassembly) and the second end is the trailing end of the inflatable tubular envelope (i.e., end that is proximate to the buffering subassembly). In another embodiment of the present teachings, the first end is the trailing end of the inflatable tubular envelope, and the second end is the leading end of the inflatable tubular envelope.

Method 900 then proceeds to element 908. Element 908 includes sealing the first end of the inflatable tubular envelope. Sealing can be accomplished using a sealing mechanism (e.g., sealing mechanism 212 of FIG. 2C). In one implementation of the present teachings, a partial seal is created to leave an unsealed portion for later gas infusion.

Following element 908, element 910 is carried out. Element 910 includes dispensing a predetermined volume of a gas admixture into the internal cavity using a gas diffuser (e.g., gas diffuser 206 of FIG. 2E). The gas diffuser is coupled to a gas admixture reservoir and introduces the gas admixture to create an inflatable tubular envelope having defined therein an inflated internal cavity. In one embodiment of the present teachings, the gas admixture may include a predetermined volume of lifting gas and a predetermined volume of aerosol composition, in liquid, gas or solid form. In one embodiment of the present teachings, the gas diffuser is inserted through the unsealed portion of the first end.

The process continues with element 912, which includes sealing the second end of the inflatable tubular envelope to produce the high-altitude balloon from the continuously dispensed inflatable tubular envelope. This is accomplished by a sealing mechanism (e.g., sealing mechanism 211 of FIG. 2H). In one embodiment of the present teachings, the unsealed portion of the first end is sealed contemporaneously with sealing the second end.

Next, a step 914 includes separating using a separating mechanism (e.g., separating mechanism 208 of FIG. 2) the completed high-altitude balloon from the inflatable tubular envelope.

The completed high-altitude balloon is moved and launched. Element 916 includes conveying, using a conveying assembly (e.g., conveying assembly 244 of FIG. 2J), that moves the balloon to a balloon launcher. In one embodiment of the present teachings, the conveying assembly includes using one or more air blowers to prevent physical contact with the delicate envelope.

Following element 916, element 918 is carried out. Element 918 includes launching the high-altitude balloon from the launcher. In a preferred embodiment of the present teachings, the launcher is in the same facility where elements 902 through 916 were carried out. The launcher, by way of example, is a roof opening in the manufacturing facility.

Method 900, in one implementation of the present teachings, includes an element of gathering, using a gathering subassembly (e.g., gathering subassembly 234 of FIG. 2D), and a section of the inflatable tubular envelope adjacent to the second end to define a deflated internal cavity. This gathered portion, which has a deflated internal cavity, is adjacent to the second end. The deflated internal cavity and the inflated internal cavity are configured to accommodate expansion of the predetermined volume of gas admixture during ascent to the target altitude. The gathering element may be performed before, contemporaneously, or after dispensing the predetermined volume of gas admixture into the internal cavity of the inflatable tubular envelope.

In a preferred embodiment gathering element is performed contemporaneously with dispensing a predetermined volume of gas admixture. The inflatable tubular envelope continuously dispensed from the buffering assembly is gathered by the gathering subassembly. As a result, the gas diffuser and the inflatable tubular envelope having the internal cavity that undergoes inflation may remain stationary, thereby reducing disturbance and potential damage during filling. On one implementation of the present teachings, during the gathering element, the buffering assembly dispenses the inflatable tubular envelope at a reduced exit velocity compared to the exiting velocity of the distributing element (i.e., distributing the tubular film to produce an inflatable tubular envelope).

In another embodiment of the present teachings, as discussed above, the first end is the trailing end of the inflatable tubular envelope and the second end is the leading end of the inflatable tubular envelope. During a gathering element, which is similar to gathering element 1010 discussed above, the inflatable tubular envelope adjacent to the leading end is gathered to form a gathered portion. Next, a separating element is carried out, which includes separating the inflatable tubular envelope at the trailing end. Next, a dispensing element is performed, which includes dispensing, using a gas diffuser and into the internal cavity through the trailing end, a predetermined volume of gas admixture, to produce the inflatable tubular envelope having defined therein an inflated internal cavity. Optionally, one or more straps secure the gathered portion.

Following the dispensing element, a sealing element includes sealing the trailing end. If not already sealed, the leading end may also be sealed. The moving element and launching element, as discussed above, may then be carried out.

As discussed above, multi-gore balloons may also be manufactured. To this end, method 900 includes an element of obtaining two or more tubular films. Next, a flattening is carried out that includes flatting each of the tubular films to create two or more flattened films. After the two or more flattened films are created, a cutting element, which includes cutting longitudinally along a length of each flattened film to create two sealable open edges is performed. Next, an unfolding element includes unfolding each of the flattened films.

Next, using first aligning and sealing element, an element includes aligning and sealing a first sealable open edge of one of the flattened films with the first sealable open edge of another of the flattened films to form the inflatable tubular envelope.

Using a second aligning and sealing element, an element includes aligning and sealing a second sealable open edge of one of the flattened films with a second sealable open edge of another of the flattened films. The first aligning and sealing element and the second aligning and sealing element form the inflatable tubular envelope.

The same elements discussed above may be used to produce a ballon having any number of gores. For example, a four-gore balloon includes the additional elements of, using a third aligning and sealing element, aligning and sealing a first sealable open edge of another of the flattened films with a first sealable open edge of another of the flattened films. Using a fourth aligning and sealing element, aligning and sealing a second sealable open edge of another of the flattened films with a second sealable open edge of yet another of the flattened films. The first aligning and sealing element, the second aligning and sealing element, the third aligning and sealing element, and the fourth aligning and sealing element form the inflatable tubular envelope

The present teachings offer, among other things, different methods of continuous manufacture and launch of high-altitude aerosol balloons, i.e., balloons designed for controlled payload dispersal at a target altitude. The present teachings recognize that the target altitude may be a specific altitude or an altitude range or band, and any altitude within the altitude range or band is the target altitude.

In one embodiment of the present arrangements, the target altitude is an altitude that ranges from about 5 kilometers and about 45 kilometers. In a preferred embodiment of the present arrangements, the target altitude is an altitude that ranges from about 10 kilometers and about 35 kilometers. In a more preferred embodiment of the present arrangements, the target altitude is an altitude that ranges from about 15 kilometers and about 30 kilometers.

FIG. 10 shows a method of continuous manufacture and launch of an aerosol balloon 1000, according to one embodiment of the present teachings. Method 1000 begins with an element 1002, which includes producing an inflatable tubular envelope (e.g., inflatable tubular envelope 210 of FIG. 2A) extending from a first end to a second end and having defined therebetween an internal cavity. This envelope can be continuously produced by a film production apparatus (e.g., film production apparatus 102 of FIG. 1).

Next, an element 1004 is carried out. Element 1004 includes creating an unsealed portion at the first end by partially sealing the first end. This partial seal may be accomplished by a first sealing mechanism (e.g., first sealing mechanism 212 of FIG. 2C), leaving a small opening to allow gas dispensing.

Method 1000 proceeds with element 1006, which includes inserting a gas diffuser (e.g., gas diffuser 206 of FIG. 2E) through the unsealed portion of the first end and into the internal cavity. A gas diffuser is used to ensure high-speed, controlled gas flow.

Following element 1006, element 1008 includes dispensing a predetermined volume of gas admixture into the internal cavity at or near the first end, defining an inflated internal cavity. This predetermined volume of gas admixture includes a predetermined volume of an aerosol composition, in liquid, gas, and/or solid form, and a predetermined volume of a lifting gas composition. In one embodiment of the present teachings, the predetermined volume of lifting gas corresponds to the target altitude of the aerosol injection balloon.

Next, element 1010 is carried out, which includes gathering a section of the inflatable tubular envelope adjacent to the second end to define a deflated internal cavity. In one embodiment of the present teachings, a gathering subassembly (e.g., gathering subassembly 234 of FIG. 2D) manipulates the inflatable tubular envelope (to create controlled folds, such as a Z-fold or accordion fold. This deflated internal cavity and the inflated internal cavity are configured to accommodate volumetric expansion of the predetermined volume of gas admixture during ascent to the target altitude.

Following element 1010, element 1012 is performed. Element 1012 includes sealing the first end and the second end such that the deflated internal cavity is disposed adjacent to the inflated internal cavity inside the aerosol injection balloon. This sealing is performed, for example, by a sealing mechanism (e.g., second sealing mechanism 211 of FIG. 2H and first sealing mechanism 212 of FIG. 2H). During ascent, the high-altitude aerosol balloon accommodates gas expansion until reaching the target altitude. When continued expansion exceeds the combined accommodation capacity of both cavities, the high-altitude aerosol balloon ruptures and disperses the aerosol composition into the atmosphere.

The present arrangements and teachings also provide systems and methods for real-time modification of balloon parameters or characteristics in response to changing environmental conditions, mission requirements, and flight trajectory predictions. This capability is achieved through the integrated control of multiple manufacturing subsystems operating in coordination under a centralized controller that continuously monitors environmental data, manufacturing parameters, and mission objectives to make instantaneous adjustments to the production process.

In one embodiment of the present teachings, the environmental data, manufacturing parameters, and mission objectives feeds into an environmental modeler that constructs harmonized vertical atmospheric profiles encompassing at least one environmental parameter selected from a group including wind velocity, temperature, pressure, humidity, solar irradiance, lightning risk, and precipitation patterns by altitude. The trajectory optimization engine then performs multiple simulations, for example using Monte Carlo simulation, using varied burst altitudes, ascent rates, and descent speeds to generate multiple predicted flight paths, validating each against mission requirements and safety constraints including ATC no-fly zones, lightning-risk regions, excessive wind shear, and atmospheric inversions that could prevent successful ascent.

The multiple predicted flight paths may be processed in a parameter optimization module to determine one or more optimized balloon parameters to achieve mission requirements. Parameter optimization may be achieved by various optimization methodologies. By way of example, Model Predictive Control (MPC) provides systematic constraint handling and time-varying optimization by treating the atmospheric-balloon system as a plant model with production parameters as control variables, solving constrained optimization problems over receding time horizons of 6-24 hours. By way of another example, Multi-objective Pareto optimization, using evolutionary algorithms such as non-dominated sorting genetic algorithm II (NSGA-II), is implemented to explore trade-off between competing objectives of cost minimization, payload delivery maximization, and risk reduction, generating Pareto frontiers that enable explicit management of performance trade-offs. By way of yet another example, reinforcement learning approaches employ deep Q-networks or actor-critic agents that learn optimal parameter selection through historical launch outcomes, continuously adapting to seasonal patterns and equipment changes through online learning mechanisms. By way of yet another example, rule-based expert systems using hierarchical decision trees with transparent if-then logic structures, adaptive Bayesian optimization employing Gaussian processes to handle uncertainty in parameter-performance relationships, and dynamic programming formulations that pre-compute value functions for rapid real-time decisions in well-defined state spaces.

In a preferred embodiment of the present teachings, a hierarchical cost-optimization strategy is implemented, using low-cost levers as the primary adjustment mechanism, including fill gas composition modifications (lift-to-payload ratios of 70-100% payload by mass), temperature adjustments for enhanced early ascent, overfill volumes of 0-30% above neutral buoyancy, and envelope coatings such as anti-static, hydrophobic, UV-resistant, and slip treatments applied based on atmospheric and production line conditions. Medium-cost levers are activated when necessary to meet trajectory requirements, encompassing envelope thickness modifications (8-50 micrometers), material composition changes with optional electron-beam cross-linking, balloon geometry adjustments for improved aerodynamics and shear resistance, and payload configuration modifications including sensor packages, ballast, or tow balloons. High-cost levers such as production halts, launch delays, or stockpiling operations are reserved for extreme conditions when lower-cost modifications cannot achieve mission objectives within acceptable risk parameters.

The manufacturing execution system translates optimized parameters into equipment commands that control various aspect of balloon production through synchronized operation of one or multiple subsystems. By way of example, to modify film thickness, the film production apparatus may use one or more of extruder die gap adjustments for thickness modification, blow-up ratio optimization through internal bubble pressure and external cooling management, and draw-down ratio adjustments via nip roller speed variations. By way of another example, the gas injection system controls provide real-time metering of lifting gas and payload compositions, precise temperature control and pressure regulation to optimize initial balloon shape and buoyancy characteristics. By way of another example, heat sealing mechanisms operate under dynamic temperature control with variable dwell times and seal widths and seal pressures to accommodate changing material properties and ensure gas-tight envelope integrity.

The integration of predictive modeling with automated control loops enables proactive parameter modification that anticipates changing conditions before they impact balloon performance. The system continuously monitors the age and accuracy of atmospheric data, automatically adding sensor payloads to subsequent balloons when telemetry exceeds staleness thresholds or when model-sensor disagreements indicate insufficient atmospheric characterization. This comprehensive approach transforms balloon manufacturing from a static production process into a dynamic optimization system capable of producing balloons specifically tailored to current and predicted atmospheric conditions, maximizing mission success rates while maintaining operational efficiency and safety standards throughout the continuous manufacturing and launch process.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly, and in a manner consistent with the scope of the invention, as set forth in the following claims.

1. A system for continuous manufacture and launch of high-altitude balloons, the system comprising:
a film production apparatus configured to continuously produce a tubular film;
a buffering subassembly communicatively coupled to the film production apparatus and capable of producing an inflatable tubular envelope extending from a first end to a second end and having defined therein an internal cavity;
a first sealing mechanism configured to at least partially seal the first end of the inflatable tubular envelope;
a gas reservoir containing a gas;
a gas diffuser coupled to the gas reservoir and configured to dispense into the internal cavity a predetermined volume of gas;
a second sealing mechanism configured to seal the second end of the inflatable tubular envelope to produce the high-altitude balloon;
a separating mechanism configured to separate the high-altitude balloon from the inflatable tubular envelope;
a conveying assembly configured to displace the high-altitude balloon from the separating mechanism; and
a balloon launcher designed to receive the high-altitude balloon from the conveying assembly and configured to launch the high-altitude balloon.

2. The system for continuous manufacture and launch of high-altitude balloons of claim 1, wherein the film production apparatus includes at least one film production apparatus selected from a group comprising film blower, caster, flat die extruder, laminator, co-extruder, and molds and dipper.

3. The system for continuous manufacture and launch of high-altitude balloons of claim 1, wherein the first sealing mechanism and/or the second sealing mechanism is a sealing mechanism selected from a group comprising heat sealer, cold sealer, laser sealer, impulse continuous band sealer, impulse continuous wheel sealer, radio frequency welder, and vertical form fill sealer.

4. The system for continuous manufacture and launch of high-altitude balloons of claim 1, wherein the first sealing mechanism is configured to seal the first end of the inflatable tubular envelope after the gas diffuser dispenses the predetermined volume of gas into the internal cavity.

5. The system for continuous manufacture and launch of high-altitude balloons of claim 1, wherein the buffering subassembly is designed to receive the tubular film at a receiving velocity and distribute the inflatable tubular envelope at an exiting velocity that is the same as or different than the receiving velocity.

6. The system for continuous manufacture and launch of high-altitude balloons of claim 1, wherein the buffering subassembly includes one or more tension accumulators configured to maintain tubular film tension during variable exiting velocity.

7. The system for continuous manufacture and launch of high-altitude balloons of claim 1, wherein the inflatable tubular envelope is made from at least one material selected from a group comprising latex, linear low-density polyethylene, polyethylene, polyamide, polyethylene terephthalate (PET), biaxially oriented polyethylene terephthalate (BOPET), ethylene-vinyl acetate (EVA), and polyvinylidene chloride (PVDC).

8. The system for continuous manufacture and launch of high-altitude balloons of claim 1, wherein the inflatable tubular envelope has a uniform sidewall thickness that ranges from between about 0.5 micrometers and about 100 micrometers.

9. The system for continuous manufacture and launch of high-altitude balloons of claim 1, wherein an internal diameter of the internal cavity is substantially similar between the first end and the second end.

10. The system for continuous manufacture and launch of high-altitude balloons of claim 9, wherein the internal diameter ranges from between about 1 meter and about 60 meters.

11. The system for continuous manufacture and launch of high-altitude balloons of claim 1, wherein the gas includes a lifting gas and a payload in predetermined proportions.

12. The system for continuous manufacture and launch of high-altitude balloons of claim 11, wherein the payload includes at least one aerosol composition selected from a group comprising SO2, H2S, H2SO4, OCS, CaCO2, AlO, Al2O2, Al2O3, SiO2, TiO₂, diamond dust, and black carbon.

13. The system for continuous manufacture and launch of high-altitude balloons of claim 11, wherein the lifting gas is at least one lifting gas selected from a group comprising helium, hydrogen, coal gas, ammonia, and methane.

14. The system for continuous manufacture and launch of high-altitude balloons of claim 1, wherein the separating mechanism includes at least one mechanism selected from a group comprising slitting roller blades, scissor blades, laser cutters, and knife blades.

15. The system for continuous manufacture and launch of high-altitude balloons of claim 1, wherein the conveying assembly includes air blowers configured to push and guide the high-altitude balloon without physical contact between the conveying assembly and the high-altitude balloon.

16. The system for continuous manufacture and launch of high-altitude balloons of claim 1, further comprising a controller operably connected to at least one component selected from the group consisting of the film production apparatus, the buffering subassembly, the first sealing mechanism, the second sealing mechanism, the gas diffuser, the separating mechanism, the conveying assembly, and the balloon launcher, wherein the controller is configured to continuously monitor at least one parameter selected from the group consisting of environmental conditions, mission requirements, and flight trajectory predictions, and control operation of the at least one component based on the monitored parameter.

17. The system for continuous manufacture and launch of high-altitude balloons of claim 16, wherein the controller controls operation of the at least one component to manufacture the high-altitude balloon such that, when launched, the balloon achieves at least one target selected from the group consisting of target flight path, target altitude, and target landing zone.

18. The system for continuous manufacture and launch of high-altitude balloons of claim 17, wherein the at least one component dynamically adjusts at least one of inflatable tubular envelope thickness, gas composition, inflatable tubular envelope thickness fill volume, gas temperature, inflatable tubular envelope length, or internal diameter of inflatable tubular envelope.

19. (canceled) A system for continuous manufacture of aerosol injection balloons, the system comprising:
a gas admixture reservoir containing an aerosol composition and a lifting gas composition,
a gas diffuser coupled to said gas admixture reservoir and configured to dispense a predetermined volume of gas admixture into an inflatable tubular envelope;
a sealing mechanism configured to partially seal a first end of said inflatable tubular envelope to create an unsealed portion and to seal both ends after gas dispensing;
a gathering subassembly configured to gather a section of said inflatable tubular envelope adjacent to a second end to form a deflated internal cavity;
wherein said gas diffuser is configured to dispense said predetermined volume of gas admixture through said unsealed portion to define an inflated internal cavity, said predetermined volume including a predetermined volume of said aerosol composition and a predetermined volume of lifting gas composition corresponding to a target altitude of an aerosol injection balloon.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. A method for continuous manufacture and launch of high-altitude balloons, the method comprising:
continuously producing a tubular film;
receiving, at a buffering subassembly, the tubular film,
producing, from the tubular film and using the buffering subassembly, an inflatable tubular envelope extending from a first end to a second end and having defined therein an internal cavity;
sealing, using a first sealing mechanism, at least a portion of the first end of the inflatable tubular envelope;
dispensing, using a gas diffuser, a predetermined volume of gas into the internal cavity, to produce the inflatable tubular envelope having defined therein an inflated internal cavity;
sealing, using a second sealing mechanism, the second end of the inflatable tubular envelope to produce the high-altitude balloon having defined therein the inflated internal cavity;
separating, using a separating mechanism, the high-altitude balloon from the inflatable tubular envelope dispensed from the buffering subassembly;
displacing, using a conveying assembly, the high-altitude balloon from the separating mechanism; and
launching the high-altitude balloon received from the conveying assembly, the launching being performed from a launch facility co-located with the film production apparatus.

35. The method for continuous manufacture and launch of the high-altitude balloons of claim 34, further comprising gathering a section of the inflatable tubular envelope adjacent to the second end to define a deflated internal cavity, wherein said deflated internal cavity and said inflated internal cavity are configured to accommodate expansion of said predetermined volume of gas admixture during ascent to a target altitude.

36. The method for continuous manufacture and launch of the high-altitude balloons of claim 35, wherein gathering the section of the inflatable tubular envelope is carried out contemporaneously with dispensing a predetermined volume of gas admixture into the internal cavity.

37. The method for continuous manufacture and launch of the high-altitude balloons of claim 34, the buffering subassembly receives the tubular film at a receiving velocity and produces the inflatable tubular envelope at an exiting velocity that is the same as or different than the receiving velocity.

38. The method for continuous manufacture and launch of the high-altitude balloons of claim 37, wherein during gathering the section of the inflatable tubular envelope, the buffering subassembly produces the inflatable tubular envelope at a reduced exiting velocity.

39. The method for continuous manufacture and launch of the high-altitude balloons of claim 34, wherein sealing the first end of the inflatable tubular envelope includes creating an unsealed portion at the first end by partially sealing the first end.

40. The method for continuous manufacture and launch of the high-altitude balloons of claim 39, wherein sealing the second end includes sealing the unsealed portion at the first end.

41. The method for continuous manufacture and launch of the high-altitude balloons of claim 34, wherein separating the high-altitude balloon includes cutting the tubular film using an automated cutting mechanism.

42. The method for continuous manufacture and launch of the high-altitude balloons of claim 34, wherein the balloon launcher is a roof opening.

43. The method for continuous manufacture and launch of the high-altitude balloons of claim 34, further comprising securing the gathered portion of the inflatable tubular envelope with temporary straps.

44. The method for continuous manufacture and launch of the high-altitude balloons of claim 34, further comprising controlling, using a controller and based on environmental conditions, mission requirements, and/or flight trajectory predictions, operation of at least one component selected from the group comprising the film production apparatus, the buffering subassembly, the first sealing mechanism, the second sealing mechanisms, the gas diffuser, the separating mechanism, the conveying assembly, and/or the balloon launcher, and controls operation of at least one of the components to manufacture the high-altitude balloon that, when launched, meets mission requirements of target flight path, target altitude, and/ or target landing zone.

45. The method for continuous manufacture and launch of the high-altitude balloons of claim 34, further comprising:
obtaining two or more tubular films;
flattening cach of the tubular films to create two or more flattened films;
cutting longitudinally along a length of each flattened film to create two sealable open edges;
unfolding each of the flattened films;
a first aligning and sealing element including aligning and sealing a first sealable open edge of one of the flattened films with the first sealable open edge of another of the flattened films to form the inflatable tubular envelope;
a second aligning and sealing element including aligning and sealing a second sealable open edge of one of the flattened films with a second scalable open edge of another of the flattened films, and wherein the first aligning and sealing element and the second aligning and sealing element form the inflatable tubular envelope.

46. (canceled)
